(19) United States
(12) Patent Application Publication
(10) Pub. No.: US 2026/0240406 A1
(43) Pub. Date: Aug. 20, 2026

(54) SUPPORT FRAME

(71) Applicant: ALWA GMBH & CO. KG KG KONSTRUKTION & FORMENBAU, Deisslingen (DE)

(72) Inventor: Hans SCHWARTZ, Warthausen (DE)

(73) Assignee: ALWA GMBH & CO. KG KG KONSTRUKTION & FORMENBAU, Deisslingen (DE)

(21) Appl. No.: 19/498,608

(22) PCT Filed: Apr. 15, 2024
(86) PCT No.: PCT/EP2024/060156

§ 371 Date: Dec. 31, 2025

(30) Foreign Application Priority Data
Apr. 17, 2023 (DE) 20 2023 101 952.8

(51) Int. Cl. A47L 15/50; F16M 11/04; F16M 11/22

(52) U.S. Cl. CPC A47L 15/501; F16M 11/041; F16M 11/22

(57) ABSTRACT

A support frame with a frame within which a plurality of first webs and a plurality of second webs are arranged, which intersect with the first webs to form at least one receiving opening. The first webs and/or the second webs are oriented at an angle to the frame.

### DESCRIPTION

The invention relates to a support frame with a frame within which a plurality of first webs and a plurality of second webs are arranged, which intersect with the first webs to form at least one receiving opening, wherein the first webs and/or the second webs are oriented at an angle to the frame.

EP 3 480 128 B 1 from the same applicant discloses a support frame with the features of the preamble of claim 1, which has proven itself well in practice and is used in particular to store a plurality of objects on the support frame and to make them available together for processing, for which the objects are, for example, automatically removed from the support frame one after the other in a pick-and-place process and returned to the support frame after processing. Another possible application is one in which the objects arranged on the support frame are subjected to a processing step together and the support frame with the objects is moved for this purpose. An example of this is use in a dishwasher, in particular a dishwashing machine, in which cleaning media with elevated temperatures are also used and act on the support frame.

The stability of the support frame is of great importance here, as high stability facilitates automated processing and is helpful for good definition of the position of the objects at all times, i.e., deformation of the support frame, which would cause the objects stored on it to tip over, should be avoided as far as possible.

It is therefore the task of the present invention to design a support frame in such a way that deformation in the plane of the support frame is counteracted.

This task is solved by a support frame with the features of claim 1. Advantageous embodiments with appropriate further developments of the invention are specified in the dependent claims.

The support frame according to the invention is characterized in that the webs are at least partially not aligned parallel to the edges of the frame, so that the webs act as stiffening ribs, not only to increase the bending stiffness in the longitudinal and transverse directions, but also with regard to torsional forces that cause the support frame to twist.

A particularly large increase in torsional stiffness is achieved when the first webs and the second webs are inclined at an angle of 45° to the frame and forces acting on a corner of the frame are evenly distributed into the frame with the first webs and the second webs.

It is also advantageous if the at least one receiving opening is square and the receiving opening is provided multiple times, with a snap-fit being formed in a plurality of the receptacles, into which a connecting body provided with snap-fit means can be detachably inserted. This design of the receiving openings results in a symmetrical grid in which moving from one receiving opening to an adjacent receiving opening requires the same distance, which is advantageous in terms of the automated processing of the objects received in the receiving openings. Flushing openings are formed between the frame-side receptacles and the frame.

The support frame is particularly useful when a connecting body is inserted into at least one of the receiving openings designed with a snap-fit seat.

The terms “locking seat” and “locking means” are to be understood in a general sense and include any type of detachable, locking connection, such as those found in ball lock bolts, bayonet connections, or push buttons. With regard to the simplicity of the design and manufacture, particularly in an injection molding process for support frames made of plastic, it is preferable for the locking seat to be formed by two locking cams arranged on opposite sides of the receptacle.

The connecting body has a base that rests on the receptacle, on the side facing away from the receptacle a retaining element is formed, and on the side facing the receptacle a retaining base is formed that can be inserted into the receptacle and which carries the locking means formed by two grooves arranged on opposite sides of the retaining base. The retaining base is narrower than the bottom of the grooves in the transverse direction to the axis connecting the two grooves, so that in a first orientation the retaining base can be inserted between the locking lugs and then brought into engagement with the locking lugs by rotation with the grooves.

It is particularly preferred if locking seats are formed in the receiving openings both on the upper side of the frame and on the lower side of the frame, as this allows the number of receiving openings to be increased in a simple manner and enables alternating use of the upper side and the lower side, which in particular also increases the maximum service life of the support frame until the wear limit is reached. For this purpose, the pair of locking cams on the underside can be assigned to the complementary sides of the pair of locking cams assigned to the top side, which allows for alternative orientation of the objects to be held if they are not rotationally symmetrical.

The depth of the recess should preferably be dimensioned such that the retaining bases inserted from above and those inserted from below are spaced apart from each other, thus preventing static friction and ensuring that the rotation of one retaining base does not affect the other retaining base.

It is also advantageous if a circumferential ring collar is formed on the edge of the underside of the frame, as this creates the possibility of a plate being detachably attached to the ring collar, with receptacles having snap-in seats being formed in the plate in a freely selectable grid pattern. The arrangement of the first webs and the second webs on both sides of the support frame specifies a grid that is not optimal or cannot be used for all applications. The plate makes it easy to provide a different grid, which can be processed in the usual manner by assigning it to the support frame.

The features and combinations of features mentioned above in the description, as well as the features and combinations of features mentioned below in the description of the figures and/or shown in the figures alone, can be used not only in the combination specified in each case, but also in other combinations or on their own, without leaving the scope of the invention. Therefore, embodiments that are not explicitly shown or explained in the figure but can be derived from the explained embodiments and can be produced by separate combinations of features are also to be regarded as disclosed by the invention.

Further advantages, features, and details of the invention are apparent from the claims, the following description of preferred embodiments, and the drawings.

The following shows:

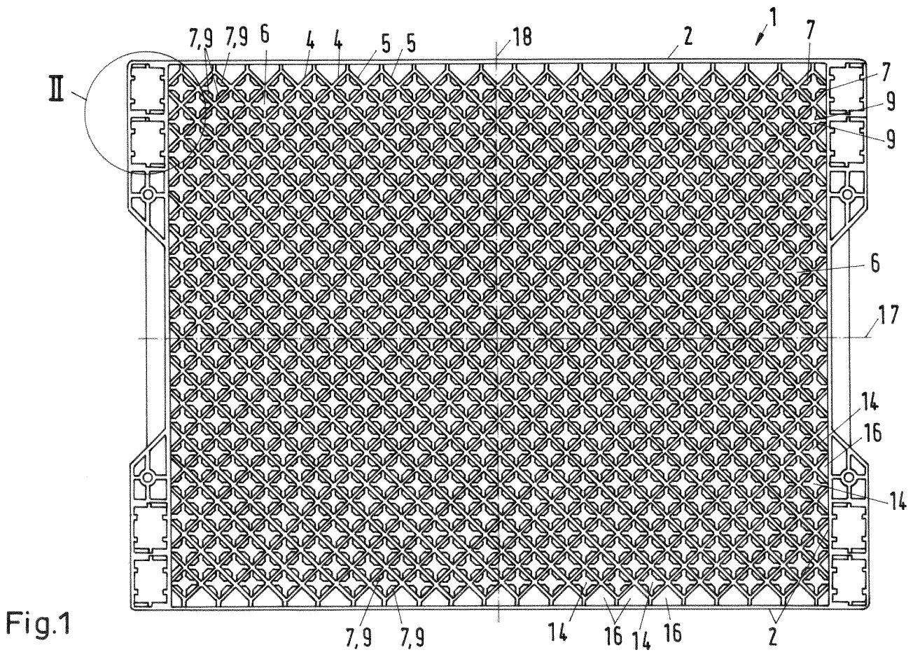

FIG. 1 a top view of a support frame,

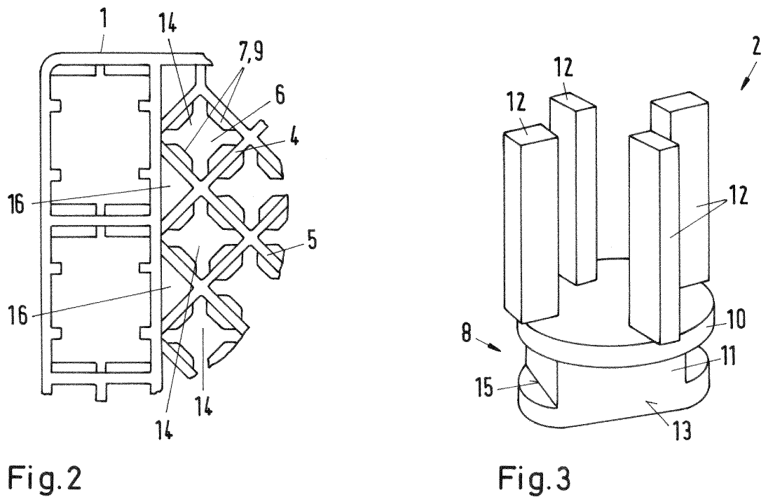

FIG. 2 detail II from FIG. 1, and

FIG. 3 a perspective view of a connecting body.

FIG. 1 shows a support frame 1 with a frame 3, within which a plurality of first webs 4 and a plurality of second webs 5 are arranged. The second webs 5 intersect with the first webs 4 to form at least one receiving opening 6. FIG. 1 shows an embodiment in which the receiving opening 6 is provided multiple times, namely in a number that fills the frame 3. In a plurality of the receiving openings 6, namely in all of them in the embodiment shown, a locking seat 7, as shown in FIG. 2, is formed, into which a connecting body 2 provided with locking means 8, as shown in FIG. 3, can be detachably inserted.

The special feature of this support frame according to the embodiment shown is that the first webs 4 and the second webs 5 are oriented at an angle to the frame 3, namely at an angle of inclination of 45°, which in particular achieves an improvement in torsional stiffness without significantly impairing the bending stiffness in the two directions 17 and 18 defined by the plane of the support frame 1.

The receiving openings 6 are square in shape, resulting in a uniform grid in the aforementioned direction. The locking seat 7 of each receiving opening 6 is formed by two locking cams 9 arranged on opposite sides of the receiving opening. These locking cams 9 serve to interact with locking means 8 on the connecting body 2, which has a base 10 that rests on the receiving opening 6, on the side of which facing away from the receiving opening 6 a retaining element 12 is formed. This retaining element 12 can be used to detachably fix objects to the support frame, for which purpose a retaining base 11, which can be inserted into the receiving opening 6 and which carries the locking means 8, is formed on the side of the base 10 facing the receiving opening 6.

In the embodiment shown, the locking means 8 are formed by two grooves 15 arranged on opposite sides of the retaining base 11, wherein the retaining base 11 is narrower than the groove base 13 in the transverse direction to the axis connecting the two grooves 15. This makes it possible to insert the retaining base 11 in an orientation between the locking cams 9 until the base 10 comes into contact, and then to rotate the retaining base 11 to engage the locking cams 9 in the grooves 15.

It should also be noted that latching seats 7 are formed in the receiving openings both on the upper side of the frame 3 and on the lower side of the frame 3, which may be of the same design. In the receiving opening 6, the pair of latching cams 9 on the lower side is assigned to the complementary sides opposite the pair of latching cams 9 assigned to the upper side. The two pairs of locking cams 9 thus use all four sides of the square receiving opening 6. Furthermore, the depth of the receiving opening 6 is dimensioned such that retaining bases 11 inserted from the top and retaining bases 11 inserted from the bottom are spaced apart from each other.

On the underside of frame 3, a circumferential ring collar is formed at the edge, onto which a plate can be detachably attached, wherein receiving openings 6 with snap-fit seats are formed in the plate in a freely selectable grid pattern. It should also be noted that rinsing openings 16 are formed between the receiving openings 14 on the frame side and the frame 3, which are particularly useful and accelerate the rinsing process when the support frame is used to clean objects attached to it with the connecting body 2 after a processing step or in preparation for the next one.

### LIST OF REFERENCE NUMBERS

1 Support frame
2 Connecting body
3 Frame
4 First web
5 Second web
6 Receiving opening
7 Locking seat
8 Locking means
9 Locking cam
10 Base
11 Retaining base
12 Retaining element
13 Groove base
14 Frame-side mounting opening
15 Groove
16 Flush opening
17 Longitudinal direction
18 Transverse direction

1. A support frame with a frame, within which a plurality of first webs and a plurality of second webs are arranged, which intersect with the first webs to form at least one receiving opening characterized in that the first webs and/or the second webs are oriented at an angle to the frame.

2. The support frame according to claim 1, wherein the first webs and the second webs are inclined at an angle of 45° to the frame

3. The support frame according to claim 1, wherein the at least one receiving opening is square in shape.

4. The support frame according to claim 1, wherein the receiving opening is provided multiple times and that a locking seat is formed in a plurality of the receiving openings into which a connecting body provided with locking means can be detachably inserted.

5. The support frame according to claim 4, wherein a connecting body is inserted into at least one of the receiving openings formed with a locking seat.

6. The support frame according to claim 4, wherein the locking seat is formed by two locking cams arranged on opposite sides of the receiving opening.

7. The support frame according to claim 5, wherein the connecting body has a base which rests on the receiving opening and on the side facing away from the receiving opening a retaining element is formed, and on the side facing the receiving opening a retaining base is formed which can be inserted into the receiving opening and which carries the locking means.

8. The support frame according to claim 7, wherein the locking means are formed by two grooves arranged on opposite sides of the retaining base and in that the retaining base is narrower in the transverse direction to the axis connecting the two grooves than a groove base.

9. The support frame according to claim 4, wherein flushing openings are formed between the frame-side mounting openings and the frame.

10. The support frame according to claim 4, wherein locking seats are formed in the receiving openings both on the upper side of the frame and on the lower side of the frame.

11. The support frame according to claim 10, wherein in the receiving opening, the pair of locking cams on the underside is as-signed to the complementary sides opposite the pair of locking cams assigned to the upper side.

12. The support frame according to claim 10, wherein the depth of the receiving openings is dimensioned such that retaining elements inserted from the top and retaining elements insert-ed from the bottom are spaced apart from each other.

13. The support frame according to claim 1, wherein a circumferential ring collar is formed on the underside of the frame at its edge.

14. The support frame according to claim 13, wherein a plate is detachably attached to the ring collar and that receiving openings with locking seats are formed in the plate in a freely selectable grid pattern.
